(19) United States
(12) Patent Application Publication
(10) Pub. No.: US 2002/0036117 A1
(43) Pub. Date: Mar. 28, 2002

(54) Safety ladder

(76) Inventors: Michael Frank Rickman, Wyandotte, MI (US); Jeffrey Michael Mitchell, Wyandotte, MI (US); Kevin Arthur Hood, Lincoln Park, MI (US)

Correspondence Address: Barbara M. Burns, 1756 Plymouth Road # 276, Ann Arbor, MI, 48105, US

(21) Appl. No.: 09/951,318

(22) Filed: Sep. 12, 2001

Related U.S. Application Data
(60) Provisional application No. 60/236,285, filed on Sep. 28, 2000.

(51) Int. Cl. A62B 1/06; E06C 1/52

(52) U.S. Cl. 182/70; 182/198

(57) ABSTRACT

A device for use for quickly and safely exiting a structure, such as a burning building. The device of the invention comprises a generally rectangular body that is hollow and fits inside the stud spacing of a structure. The body is positioned below a window and secured to the structure. A flexible ladder is secured through the body to the studs of the structure with the flexible ladder being stored within the body. The ladder can be fabricated from chain, rope or other flexible material and has cross bars for ladder rungs. Spacers behind the rungs keep the rungs spaced out from the wall. A cover plate overlays most of the rectangular body leaving an opening in the rectangular body for the ladder to be moved from a storage position within the body to a use position. A trim cover closes the opening when the device is in the storage position. The trim cover is removed from the opening to access the ladder with the trim cover weighting the bottom of the ladder for rapid deployment of the ladder out of an open window.

### CROSS-REFERENCE TO RELATED APPLICATION

This application is based on Provisional Patent Application Serial No. 60,236,285 filed Sep. 29, 2000.

### BACKGROUND OF THE INVENTION

The field of the invention pertains to safety devices and in particular, to a safety ladder. Although the use of fire and smoke alarms has greatly reduced injuries from fires, quickly exiting a burning structure is critical. But quickly exiting from a structure above grade level has been a problem, especially should a fire be blocking a stairway. Some escape devices can be hooked into a window, but finding the storage location of that type of device and firmly hooking it before it can be used can waste valuable escape time, especially when a fire is fast moving. Thus, a simple device that can be quickly activated is desired.

Therefore, a more effective device to be employed to exit a structure is an advantageous goal. Such more effective device is disclosed below.

### SUMMARY OF THE INVENTION

The invention is a device that can be affixed to a structure as the structure is built. The device can also be retrofitted to a structure if so desired. The invention comprises a generally rectangular body that is hollow and has a cover plate that covers most of the front of the body. The generally rectangular body fits inside the stud spacing of a house or other structure with the body being positioned below a window. A safety ladder is stored in the rectangular body and fixed to the studs of structure. The safety ladder device according to the invention is readily available for use in an emergency but requires no closet space or other storage space within the structure.

The rectangular body of the device can be sized and shaped as needed to meet the requirements of the structure and the body can vary as long as the body can be fitted to the structure. The rectangular body has flanges with apertures in the flanges. Apertures extend through side walls of the rectangular body to allow the device to be securely mounted with fasteners to the structure.

The rectangular body is positioned to the structure. Then a flexible ladder is securely mounted to the structure by bolts with a washer through a link of a chain link ladder and then through the rectangular body to securely attach to studs of the structure. The rectangular body thus contains a flexible ladder stored therein in a storage position with the ladder being secured to the structure through the walls of the body. The ladder can be fabricated from chain/chain link with cross bars for ladder rungs, but rope or other flexible material can be employed. The cross bars can be crimped around the chain link risers to form the rungs of the ladder.

A cover plate is fitted to the rectangular body to enclose the storage compartment leaving an opening for the ladder to be removed. The cover plate can be matched to the decor of the room by painting, wallpapering, drywalling, etc.

The opening near the top of the rectangular body allows the ladder to be moved from a storage position within the body to a use position. The opening in the rectangular body is covered by a trim cover. A bracket is mounted to the back of the trim cover. The bracket frictionally holds the trim cover to the rectangular body when the device is in the storage position. A handle on the trim plate is bolted through the attachment plate to connectors attached to the bottom of the ladder. Rubber encased loops attach around the links at the end of the ladder to securely connect the trim cover to the ladder. The trim cover adds weight to the ladder so as to assist the ladder during deployment to the use position.

The trim cover fits into the opening in the device and conceals the device when the device is in the storage position. The trim cover can match the woodwork around the window or other decorating element of the room. The trim cover can be designed to look like a cabinet drawer and can be fabricated from wood to match other cabinets in the room. Accordingly, the device is stored without detracting from the space of the interior room or the decor of the room. The trim cover can function as the bottom step of the ladder. When the trim cover is pulled off, the ladder device can be withdrawn from the storage position in the body. The trim cover can be fabricated to match the molding around the window. A handle can be added to the trim cover to facilitate the removal of the trim cover when immediate use of the device is needed. A weight can be added to the ladder to help the descent of the ladder to the use position.

Chain link or other flexible strong materials can be used for the riser portions of the ladder. Metal tubes, bars or other strong materials can be affixed across the chain link riser portion at approximately 12-inch intervals for the rungs. The metal tube ladder rungs are crimped over the chain link to attach to the chain link risers. Spacers are positioned behind the rungs or behind every other rung to hold the rung away from the structure. The spacers span less than the width of the distance between the risers. The spacers are angled downwardly 60 degrees from the vertical of the risers. The spacers allow room for the user's hands and feet as the safety ladder is used for evacuation from the structure.

To use, the trim cover is pulled and removed away from the rectangular box that is fixed to the structure, starting the removal of the ladder from the rectangular body.

The ladder is pulled from the storage position in the rectangular body. The ladder is dropped through a window that has been prepared by being opened. The ladder extends, yet is firmly attached to the structure. The spacers behind the ladder rungs facilitate use by the evacuee.

The lower part of the ladder approaches the outside ground level. Thereafter, the user can safely and quickly exit the structure via the ladder in the use position.

Beneficial aspects of the invention are firstly, that the invention can be conveniently placed to new construction at the time the structure is being built and secondly, that the device is easily and quickly used to perhaps save the live of a user.

Moreover, the device can be retrofitted with a minimum of disruption to the interior of the structure. Further, the device can be reused by being repacked into the rectangular body for use at future time.

For a more complete understanding of the present invention, reference is made to the following detailed description when read with in conjunction with the accompanying drawings wherein like reference characters refer to like elements throughout the several views, in which:

### BRIEF DESCRIPTION OF THE DRAWINGS

FIG. 1 illustrates a perspective view of the safety ladder device according to the invention;

FIG. 2 illustrates an environmental view of the safety ladder device from the outside of a structure;

FIG. 3 illustrates a perspective view of the body and the cover of the safety ladder device according to the invention;

FIG. 4 illustrates the attachment of the rungs to the ladder;

FIG. 5 illustrates the safety ladder device as mounted tot he structure with the access cover removed from the device assembly;

FIG. 6 illustrates a perspective view of the safety ladder as deployed to the use position (the outside of a structure) according to the invention; and

FIG. 7 illustrates a side partial diagrammatic view of the safety ladder device according to the invention showing the spacers.

### DESCRIPTION OF THE PREFERRED EMBODIMENT

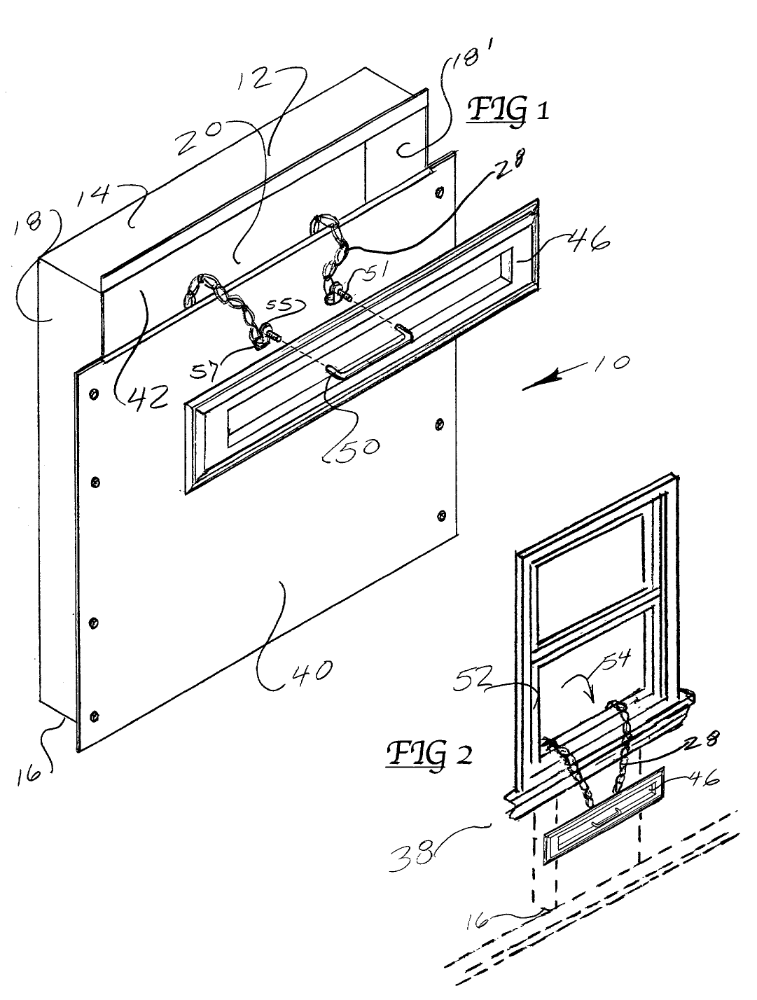

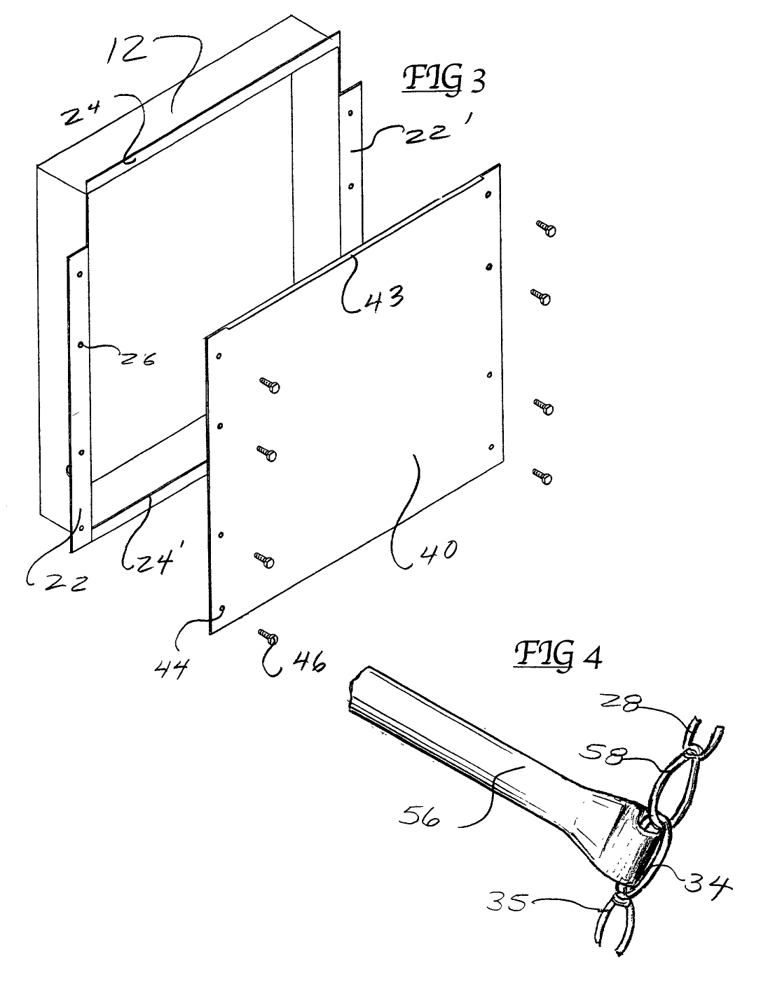

In FIG. 1, a safety ladder device 10 is illustrated as having a rectangular body 12 with a top 14, a bottom 16 and sides 18, 18′ forming an interior 20. Rectangular body 12 has flanges 22, 22′ (FIG. 3) extending perpendicularly along both of the sides 18, 18′. Flanges 22, 22′ extend almost to the top 14 of the rectangular body 12. Lips 24, 24′ extend perpendicularly from the top 14 and the bottom 16 of the rectangular body 12. Lips 24, 24′ are co-planar with the flanges 22, 22′ extending from the sides 18, 18′ of the rectangular body 12. Flanges 22, 22′ have apertures 26, 26′, etc. therethrough.

As is better shown in FIG. 5, a flexible ladder 28 is secured through the sides 18, 18′ of the rectangular body 12 by means for attaching, herein a bolt 30 with a washer 32 placed through a link 34 of the chain 35 and through the aperture 26 in the side 18 of the rectangular body 12 to engage with a stud 36 of a structure 38. Flexible ladder 28 is stored within the interior 20 of the rectangular body 12.

Cover plate 40 covers most of the front of the rectangular body 12 leaving an opening 42 to the interior 20 of the rectangular body 12 near the top 14 of the rectangular body 12. Cover plate 40 has a top edge 43 that is perpendicular to cover plate 40. Cover plate 40 partly covers rectangular body 12 forming opening 42. Cover plate 40 has apertures 44 therein through which fasteners 46 can attach cover plate 40 to the rectangular body 12 through apertures 26 on flange 22 to stud 36 of a structure 38.

Trim cover 46 for covering the opening 42 has a bracket 48 (FIG. 5) on the back of the trim cover 46 for engaging with the edges of the rectangular body 12 and with cover plate 40 that forms opening 42. Trim cover 46 has a handle 50 on the outside. Handle 50 is secured to flexible ladder 28 (FIG. 5) with means for attaching, herein depicted as machine screw 51 engaging with threaded hole (not shown) in handle 50. Head 55 of machine screw 51 holds loop 57 connected to flexible ladder 28.

Weight such as the trim cover 46 helps flexible ladder 28 with the force of gravity to extend flexible ladder 28 from the storage position within the rectangular body 12.

In FIG. 2, is better shown the safety ladder device 10 (shown in hidden lines) when mounted to a structure 38. Safety ladder device 10 is placed so as to be below a window 52 of a structure 38. Arrow 54 indicates placement of flexible ladder 28 for use to exit from structure 38.

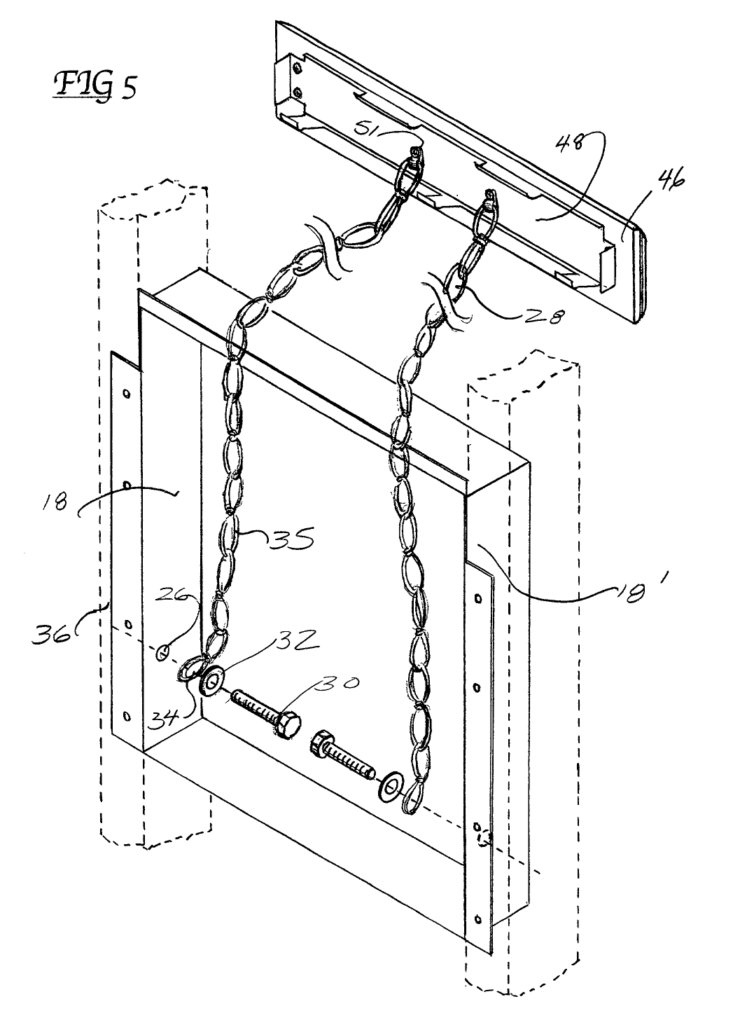

FIG. 4 depicts rung 56 of flexible ladder 28 attached to a riser 58 of flexible ladder 28 by having been crimped around a link 34 of chain 35.

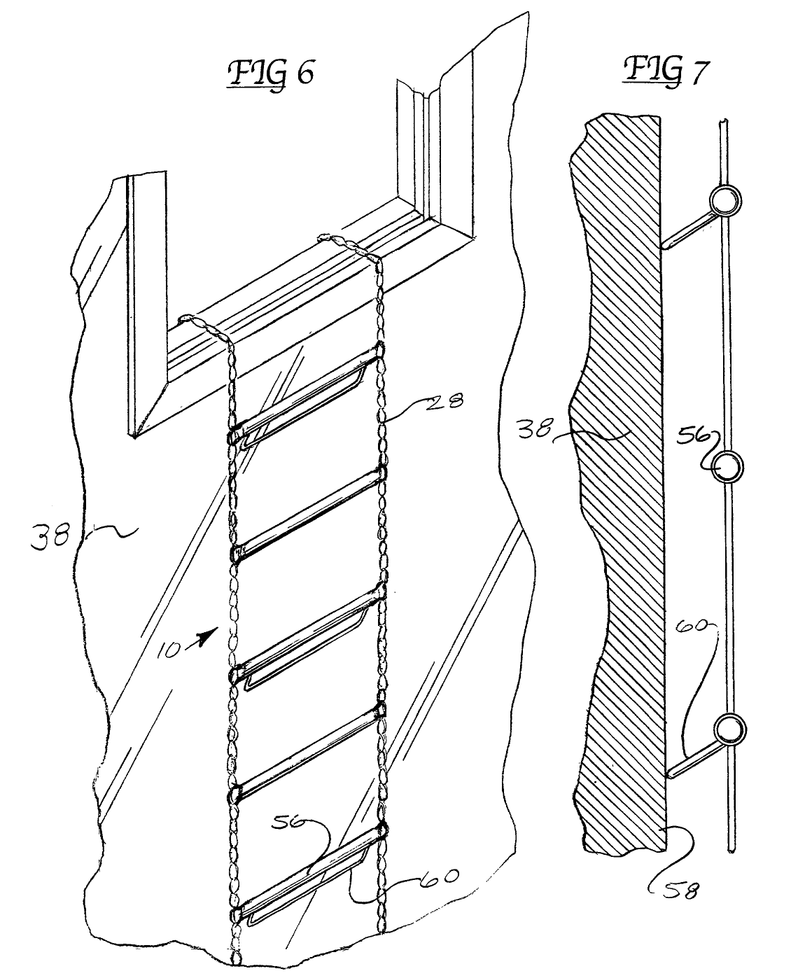

In FIG. 6, flexible ladder 28 of the device 10 is shown in the use position. Flexible ladder 28 has been deployed from the storage position in rectangular body 12 (not shown). Flexible ladder 28 has been unfurled and placed away from the face of the rectangular body 12.

FIG. 7 shows flexible ladder 28 in the deployed position with rungs 56 are on the outside 58 of structure 38, thus allowing a user to utilize the flexible ladder 28 of safety ladder device 10. Spacer 60 position ladder rung 56 away from outside 58 of structure 38.

Having described the invention, many modifications thereto will become apparent to those skilled in the art to which it pertains without deviation from the spirit of the invention as defined in the appended claims.

1. A device fittable to a structure, the device comprising
a body having a back, sides, a top and a bottom and forming an interior, the body sized to fit to the structure; and
a flexible ladder stored within the interior of the body.

2. The device according to claim 1 further comprising means for affixing the device to the structure.

3. The device according to claim 2 wherein the means for affixing the device to the structure comprises flanges on the body.

4. The device according to claim 2 wherein the means for affixing the device to the structure comprises apertures through side walls of the device and means for attaching deployed through the apertures in the side walls of the body.

5. The device according to claim 1 further comprising a trim cover.

6. The device according to claim 5 further comprising a handle on the trim cover.

7. The device according to claim 5 wherein the trim cover comprises the bottom of the flexible ladder.

8. The device according to claim 1 further comprising a weight on the ladder.

9. The device according to claim 1 wherein the flexible ladder further comprises chain link risers and metal bar rungs fixed to the chain link risers.

10. The device according to claim 9 further comprising a spacer affixed to a rung.

11. The device according to claim 1 further comprising a cover plate.

12. The device according to claim 1 wherein the flexible ladder further comprises chain link risers and metal bar rungs.
